(19) United States
(12) Patent Application Publication
(10) Pub. No.: US 2026/0210520 A1
(43) Pub. Date: Jul. 23, 2026

(54) RECONFIGURABLE VEHICULAR EXTERIOR LIGHT PROJECTION MODULE

(71) Applicant: Magna Mirrors of America, Inc., Holland, MI (US)

(72) Inventors: Eric Peterson, West Olive, MI (US); Justin E. Sobecki, Rockford, MI (US)

(21) Appl. No.: 19/448,212

(22) Filed: Jan. 14, 2026

Related U.S. Application Data
(60) Provisional application No. 63/746,384, filed on Jan. 17, 2025.

(51) Int. Cl. F21S 43/00; B60Q 1/26; F21S 43/14; F21W 103/25; F21W 103/60; H05B 47/175; H05B 47/19

(52) U.S. Cl. CPC F21S 43/601; B60Q 1/2665; B60Q 1/2669; F21S 43/14; H05B 47/19; H05B 47/1965; B60Q 2400/50; B60Q 2900/30; F21W 2103/25; F21W 2103/60

(57) ABSTRACT

A vehicular illumination module includes a housing configured to be disposed at an exterior portion of a vehicle. A printed circuit board (PCB) having an illumination source is accommodated by the housing. A masking element is accommodated by the housing and includes a plurality of patterns. When the illumination source is electrically operated to emit light, and in response to a first input, light emitted by the illumination source passes through a first portion of the masking element corresponding to a first pattern forms a first icon projected by the illumination module onto a surface on or proximate the vehicle. In response to a second input, light emitted by the illumination source passes through a second portion of the masking element corresponding to a second pattern forms a second icon projected by the illumination module onto the surface.

### CROSS REFERENCE TO RELATED APPLICATION

The present application claims the filing benefits of U.S. provisional application Ser. No. 63/746,384, filed Jan. 17, 2025, which is hereby incorporated herein by reference in its entirety.

### FIELD OF THE INVENTION

The present invention relates to illumination modules for vehicles and, more particularly, to an illumination module that projects an icon or image onto a surface at or near the vehicle.

### BACKGROUND OF THE INVENTION

It is known to provide illumination or light sources at the side of the vehicle, such as to provide security lighting or convenience lighting at the side of the vehicle. For example, such lighting devices are described in U.S. Pat. Nos. 6,349,450; 6,550,103; 5,371,659; 5,669,699; 5,823,654 and 5,497,305, which are hereby incorporated herein by reference in their entireties. Typically, such lighting devices provide illumination along the side of the vehicle and down to the ground at the side of the vehicle.

### SUMMARY OF THE INVENTION

The present invention provides an illumination module or device for a vehicle, such as for mounting at an exterior mirror assembly, for providing illumination at the side or door of the vehicle and for projecting an icon or logo onto the ground area at the side of the vehicle.

For example, a vehicular illumination module includes a housing configured to be disposed at an exterior portion of a vehicle equipped with the vehicular illumination module. A printed circuit board (PCB) is accommodated by the housing. An illumination source is disposed at the PCB. A mask or masking element is disposed within the housing and the mask includes a plurality of patterns formed at the mask. With the housing disposed at the exterior portion of the vehicle, and when the illumination source is electrically operated to emit light, light emitted by the illumination source that passes through the mask forms an icon projected by the vehicular illumination module onto a surface on or at or near the vehicle. Each pattern of the plurality of patterns corresponds to one icon of a plurality of icons projected by the vehicular illumination module. When the illumination source is electrically operated to emit light, light emitted by the illumination source passes through a portion of the mask corresponding to one pattern of the plurality of patterns and forms the corresponding one icon projected by the vehicular illumination module onto the surface at or near the vehicle.

These and other objects, advantages, purposes and features of the present invention will become apparent upon review of the following specification in conjunction with the drawings.

### BRIEF DESCRIPTION OF THE DRAWINGS

FIG. 1 is a side view of a vehicle with an illumination and projection light module at the exterior rearview mirror of the vehicle;

FIG. 2 is a perspective view of the vehicle, with the projection light module electrically operated to emit light to illuminate an icon at the ground along the side of the vehicle;

FIG. 3 is a perspective view of the projection light module;

FIG. 4 is an exploded view of the projection light module;

FIGS. 5-9 are schematic diagrams of example circuits of the projection light module;

FIGS. 10-16 are views of the vehicle, with the projection light module electrically operated to emit light to illuminate example icons at the ground along the side of the vehicle;

FIGS. 17-19 are views of another projection light module configured to rotate a plate relative to a light source to adjust the mask producing the illuminated icon; and

FIGS. 20 and 21 are views of the vehicle, with the projection light module electrically operated to emit light to illuminate example icons at the ground along the side of the vehicle.

### DESCRIPTION OF THE PREFERRED EMBODIMENTS

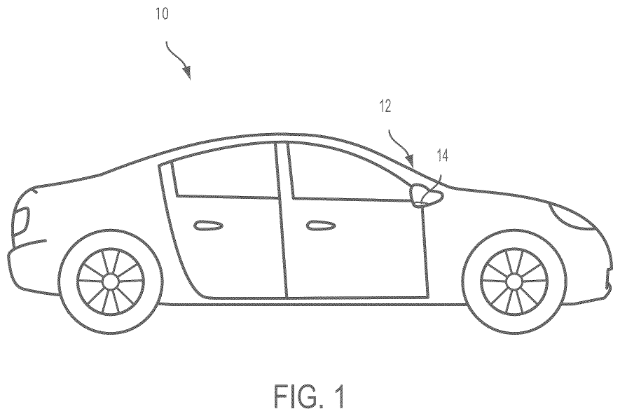

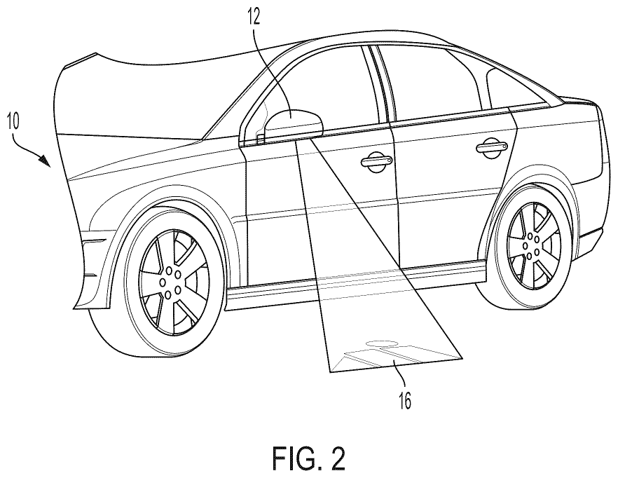

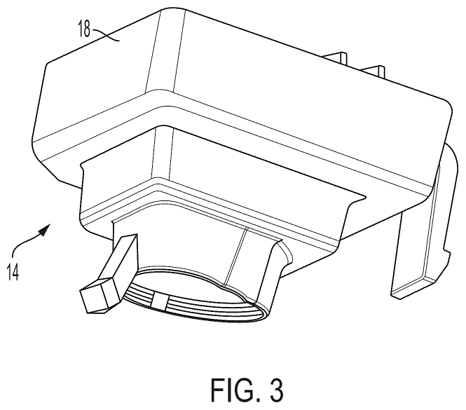

Referring now to the drawings and the illustrative embodiments depicted therein, an illumination module 14 may be disposed at a side and exterior portion of a vehicle 10, such as a vehicle exterior rearview mirror assembly 12, a door handle module, or the like, and electrically operable to emit light, where the illumination module 14 provides projection or backlighting of an image or icon or logo 16 or indicia and/or ground illumination (FIGS. 1 and 2). The illumination module 14 includes a housing or casing 18 (FIG. 3) that is configured to be received (and optionally snapped or otherwise secured) at or in an opening of the mirror assembly 12 (or elsewhere at the vehicle, such as at a door handle assembly or underbody of the vehicle such as below a driver or passenger side door or the like), with an outer portion or cover of the housing 18 being at or generally flush with the outer surface of the mirror assembly or door handle or vehicle body portion at which the illumination module is mounted. The illumination module may utilize aspects of the illumination modules described in U.S. Pat. Nos. 11,235,699; 10,744,930; 10,576,896;9,487,142; 8,801,245 and/or 8,764,256, and/or U.S. Publication Nos. US-2025-0297714; US-2024-0367581 and/or US-2015-0224919, which are hereby incorporated herein by reference in their entireties.

Typically, static projection lights project only a single artwork or logo or icon. That is, illumination modules may be operable to project one, static and non-configurable icon onto the ground near the vehicle. This lacks user customization and limits the information that can be provided by operating the illumination module. Further, because the illumination module may be disposed at a mirror head of an exterior rearview mirror assembly that moves between a folded position and an extended position, the projected icon may be projected at different positions or configurations or orientations at the ground surface based on the position of the mirror head.

As shown in FIGS. 2-4, when the illumination module 14 is electrically operated, the illumination module emits light that projects the icon or logo or image 16 onto a surface or region at or near the vehicle 10, such as the ground surface or ground region at or near or along the side of the vehicle 10. The projected image 16 may provide ground illumination at or along the side of the vehicle. In some examples, the illumination module 14 may be oriented at the vehicle to project the icon 16 onto other surfaces near the vehicle 10, such as a wall or other vertical structure, or an exterior surface of the vehicle 10, such as the door panel, hood panel, window or windshield of the vehicle, and the like.

The housing 18 of the illumination module 14 accommodates one or more electrically operable light sources 20, such as one or more light emitting diodes (LEDs) or microLEDs, that are electrically operable to emit light through one or more masks or masking elements or glass layers 22 within the module 14. The illumination module 14 may also include a condensing optic or collimator 24 and one or more projection lenses 26 that focus and magnify light as it passes from the light source 20, through the one or more masks 22 and out of the illumination module 14.

In the illustrated example, light emitted by the light source 20 passes through the condensing optic 24, then the one or more masks 22, and then the one or more projection lenses 26 before being emitted from the illumination module 14 and exterior of the vehicle 10. The one or more masks 22 block or attenuate specific spectral ranges of light emitted by the LED and passing through the condensing optic 24 so that the projection lenses 26 can magnify and project the light onto an object or surface (e.g., the ground), with the light in the form of a desired image or logo due to the image or pattern formed on the mask 22. In other words, the mask 22 includes the image or pattern to establish or define the icon that is projected by the illumination module 14.

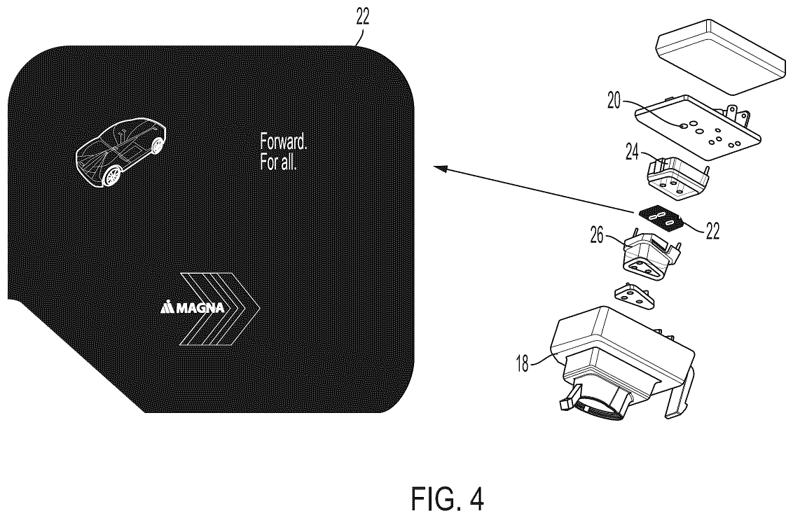

As shown in FIG. 4, the light sources 20 include a plurality of LEDs or micro LEDs disposed at a side of a printed circuit board (PCB) 28. Each LED emits light that passes through a respective condensing optic or portion of the condensing optic 24, through a respective mask or portion of the mask layer 22, and through a respective projection lens or portion of the projection lens 26 to project the image 16 onto the surface or ground. The respective masks or portions of the mask layer 22 may have respective patterns formed on the substrate (e.g., glass substrate) of the mask that correspond to different icons or images 16 projected onto the ground and each LED of the plurality of LEDs is individually operated to project the respective image 16 onto the ground. In other words, the illumination module 14 is operable to project one of a plurality of different images 16 onto the surface or ground surface by operating one or more different LEDs of the light source 20. Although shown as including three individual LEDs that each operates to project one of three individual images 16, the illumination module 14 may be configured to project any suitable number of discrete images 16, such as four or more, six or more, eight or more, and the like.

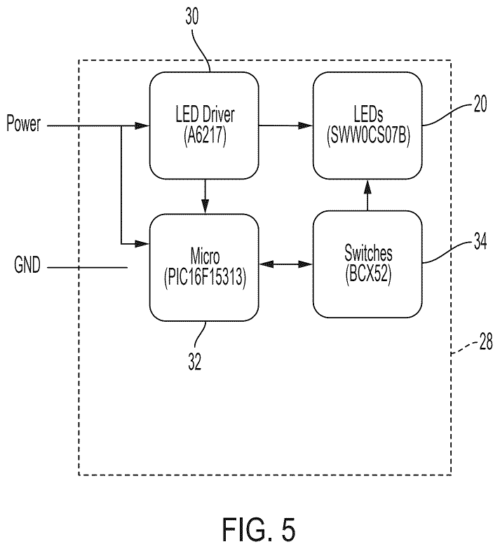

The PCB 28 may accommodate a circuit design to allow the vehicle (e.g., a control module at the vehicle) to change which LED is powered and thus which image 16 is projected onto the ground. Optionally, the circuit of the illumination module 14 may be accommodated at one or more different PCBs accommodated within the housing 18 (e.g., with individual LEDs disposed at respective PCBs). In some examples, the illumination module 14 may be controlled over a two-wire system (FIG. 5). That is, the circuit of the illumination module 14 (in the illustrated example, accommodated at the PCB 28) electrically connects to the power source of the vehicle 10 and a control module at the vehicle via a power line and a ground. The power line may supply electrical power and control signals to the illumination module 14. The illumination module 14 includes LED driver circuitry 30 that receives power from the power line and may supply power to a microcontroller 32 of the illumination module 14 and the LEDs 20. The microcontroller 32 may receive control signals from the control module of the vehicle, with the control signals indicating, for example, which LEDs to operate and/or which image to project from the illumination module 14. The microcontroller 32 may control operation of the LEDs 20 via switches 34 of the illumination module 14. This example may include unique hardware in vehicle control modules or electronic control units (ECUs).

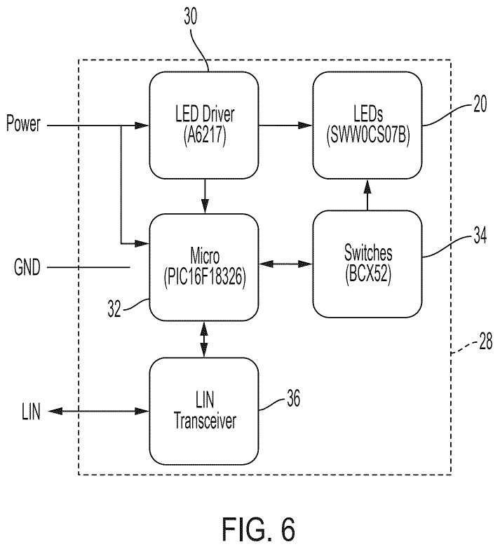

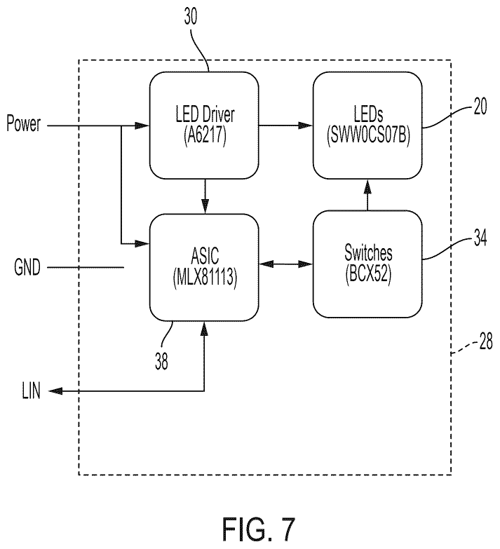

Optionally, the illumination module 14 may connect to the control module of the vehicle via a LIN bus. For example, and as shown in FIG. 6, the illumination module 14 may include a LIN transceiver 36 that connects between the LIN bus and the microcontroller 32, with the microcontroller 32 controlling operation of the LEDs 20 via switches 34. In some examples, the illumination module may include an application-specific integrated circuit (ASIC) 38 that connects to the LIN bus, with the ASIC 38 controlling operation of the LEDs 20 via switches 34 (FIG. 7). The microcontroller-based LIN may provide greater flexibility and faster response time (such as to enable projection of animations, as discussed further below), and the ASIC-based LIN may provide reduced flexibility with or without switches.

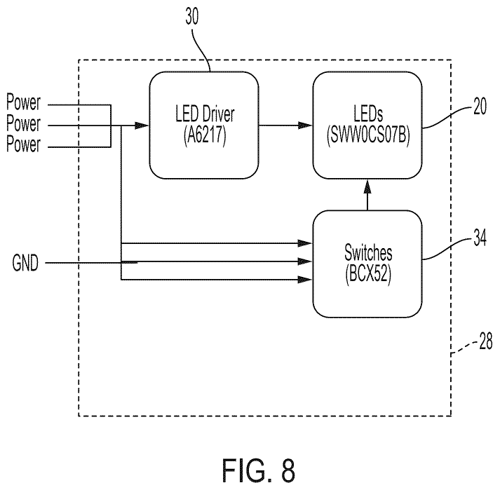

As shown in FIG. 8, the illumination module 14 may be connected to ground and include a discrete input corresponding to each LED. Each input supplies power to the respective LED 20 via the LED driver circuitry 30 and provides a control signal to the switches 34 for controlling operation of the respective LED. In the illustrated example, the PCB 28 includes three discrete input connections for receiving control signals to control operation of the three discrete LEDs 20.

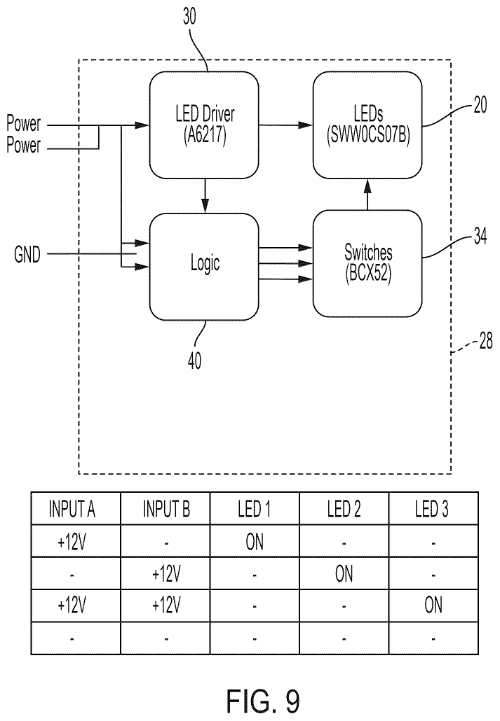

Referring to FIG. 9, operation of the LEDs 20 may be controlled via Boolean inputs. For example, the illumination module 14 may be connected to ground and two inputs that supply power to the LEDs 20 via the LED driver circuitry 30. The inputs are further adjustable (e.g., controlled via the vehicle control module) between providing one of two inputs (e.g., on and off), where the input combinations enable operation of the three or more LEDs 20. For example, a logic controller 40 at the illumination module 14 may adjust operation of the LEDs 20 via the switches 34 based on the inputs received from the dual Boolean inputs, such as according to the table in FIG. 9.

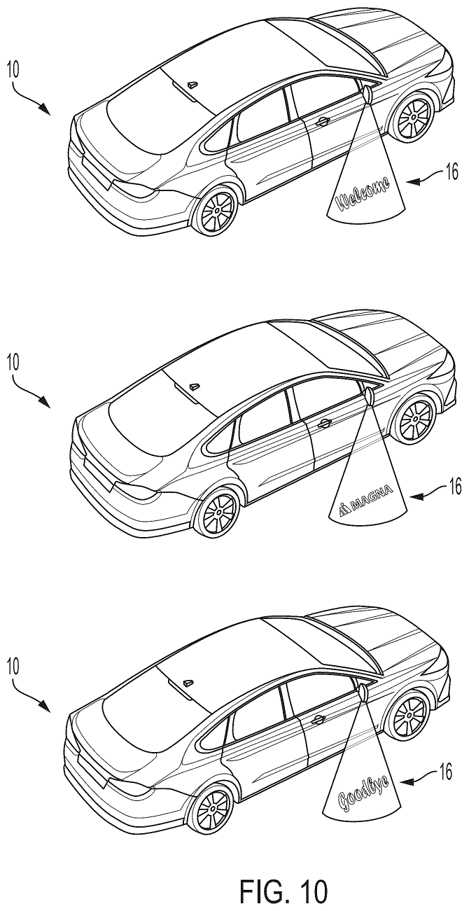

The individual masks or portions of the mask layer 22 may thus be illuminated to project different images or icons 16 onto the ground surface, and the images or icons 16 may be configured to provide different aesthetic appearances at the vehicle and/or communicate different information to the user and/or other persons or vehicles exterior the vehicle. The illumination module 14 may be operated to display one or more of the different images 16 based on one or more inputs from the driver and/or one or more systems of the vehicle 10. In the illustrated example of FIG. 10, the illumination module 14 may be operated to project a first icon or image 16 that displays a welcome message, such as responsive to receiving an unlock signal from a keyfob associated with the vehicle or responsive to determining presence of an authorized user of the vehicle (e.g., as determined based on detecting the keyfob or a mobile phone associated with the user near the vehicle) within a threshold distance of the vehicle (e.g., within 10 meters or less, within 5 meters or less, within 3 meters or less, and the like). Further, the illumination module 14 may be operated to project a second icon or image that displays a farewell or goodbye message, such as responsive to receiving a locking signal from the keyfob associated with the vehicle and/or responsive to the user exiting the vehicle and closing the vehicle door. In other situations, the illumination module 14 may be operated to display another image, such as a logo associated with the vehicle or manufacturer.

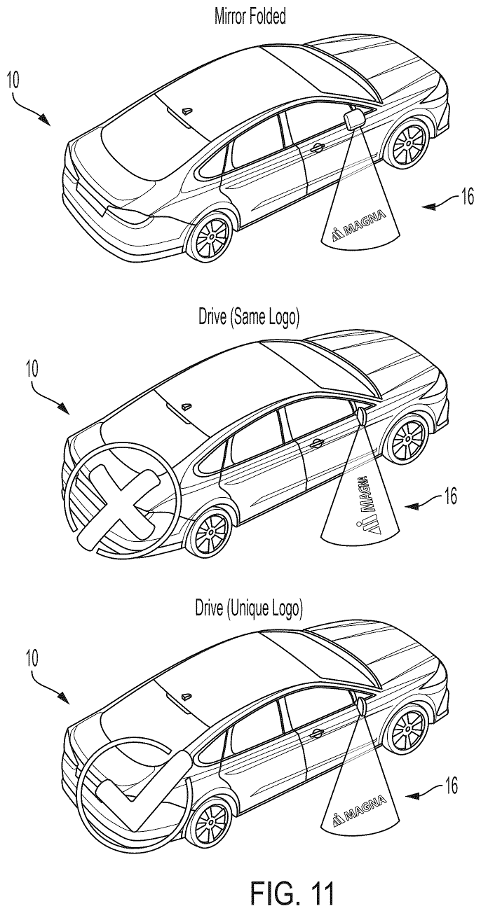

Referring to FIG. 11, the illumination module 14 may be operated to illuminate a different mask or portion of the mask layer 22 based on the position of the mirror head 12 relative to the vehicle 10. That is, because the mirror head 12 rotates between folded and extended positions, illuminating the same mask or portion of the mask layer 22 in the two positions causes the image 16 to rotate or pivot or otherwise project differently at the side of the vehicle. To project the same or substantially similar image 16 at the side of the vehicle when the mirror head is in the extended and folded positions, two or more masks or portions of the mask layer 22 may be configured differently than one another. For example, the masks or portions of the mask layer 22 may be rotated or pivoted relative to one another so that the position or orientation of the projected image 16 relative to the vehicle remains substantially the same. In other words, with the mirror head 12 in the extended position, the illumination module projects an image 16 by illuminating a first mask or portion of the mask layer and, with the mirror head 12 in the folded position, the illumination module projects the same or substantially similar image 16 by illuminating a second mask or portion of the mask layer.

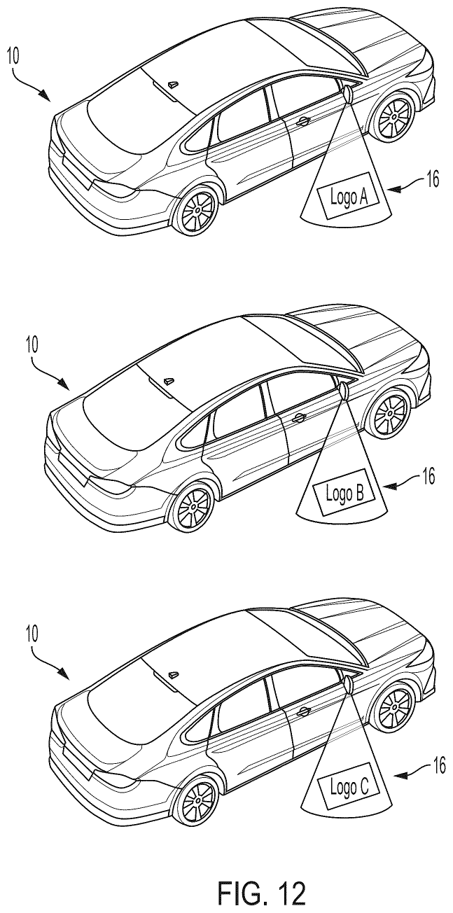

Further, the capability of the illumination module 14 to project different icons or images 16 increases the customization available between different vehicle trims or platforms. For example, and as shown in FIG. 12, the vehicle 10 may be equipped with an illumination module 14 configured to project three or more different images 16, such as one image associated with the vehicle manufacturer, one image associated with the vehicle model, and one image associated with a trim level of the vehicle. The illuminated image 16 may be user selected, such as via settings configurations of the vehicle 10.

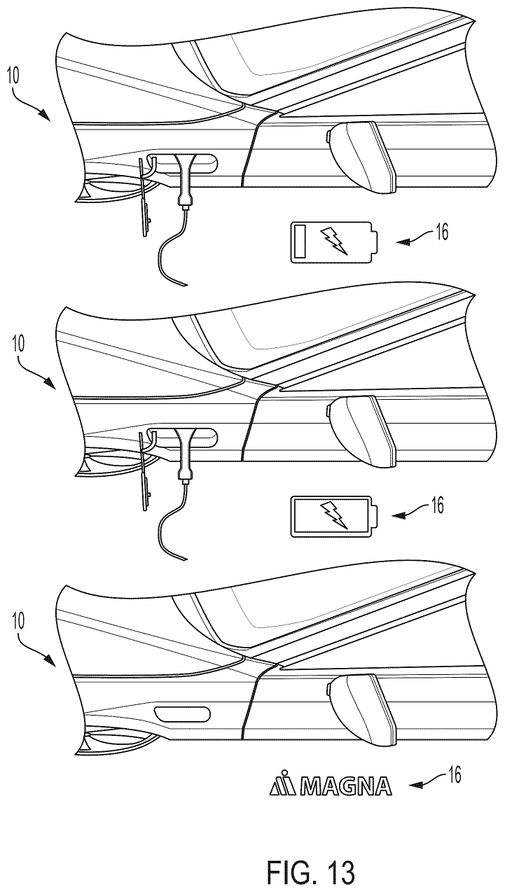

The illumination module 14 may be operated to display information related to one or more systems of the vehicle 10. For example, and as shown in FIG. 13, the illumination module 14 may be operated to project different images 16 indicating a charging status of an electric vehicle or plug-in hybrid vehicle connected to a charging system. In the illustrated example, the illumination module 14 displays a first image indicating that the battery is currently charging and a second image indicating that the battery is fully charged or charged beyond a threshold charging level. Optionally, the illumination module 14 may display different images 16 indicative of a current charge level of the battery (e.g., a first image representative of a charge level below 25 percent, a second image representative of a charge level between 25 percent and 50 percent, a third image representative of a charge level between 50 percent and 75 percent, a fourth image representative of a charge level above 75 percent, and the like). The illumination module 14 may project the image 16 in response to a user input exterior the vehicle (e.g., at the keyfob of the vehicle or at the vehicle and at or near the charging port of the vehicle), such that the user may quickly learn the charging level of the vehicle 10 before or during charging of the vehicle. The illumination module 14 may also be used to illuminate other images, such as an icon or logo associated with the vehicle. In other words, the illumination module 14 may show charging status and offer solutions for vehicle branding when not plugged in.

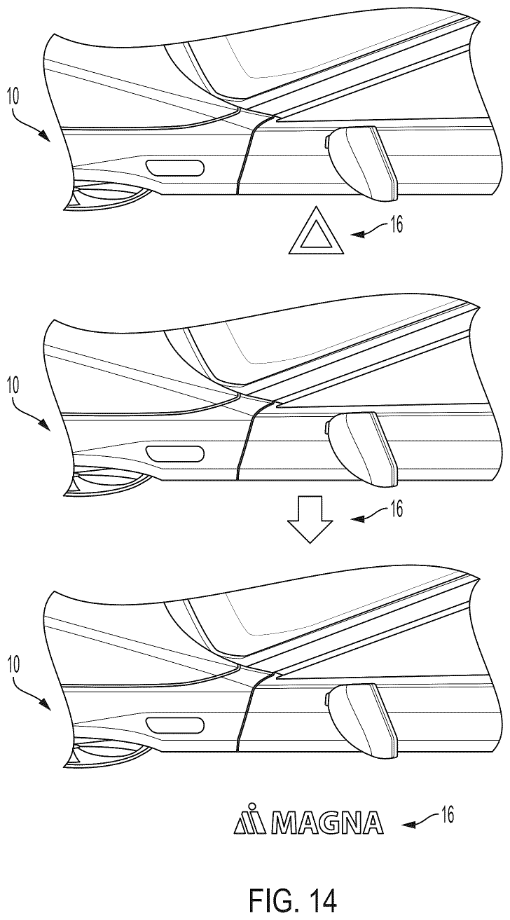

During operation of the vehicle 10, the illumination module 14 may be operated to project images 16 to display alerts or communicate messages to pedestrians or other vehicles exterior the vehicle (FIG. 14). For example, the illumination module 14 may be operated to display an arrow or other image during a turning maneuver of the vehicle to indicate which direction the vehicle is moving (e.g., responsive to activation of a turn signal indicator of the vehicle). Further, the illumination module 14 may be operated to display a hazard symbol or other image responsive to activation of the hazard lights of the vehicle 10. Thus, the module 14 may be used as a ground signal projector and a vehicle branding projection light.

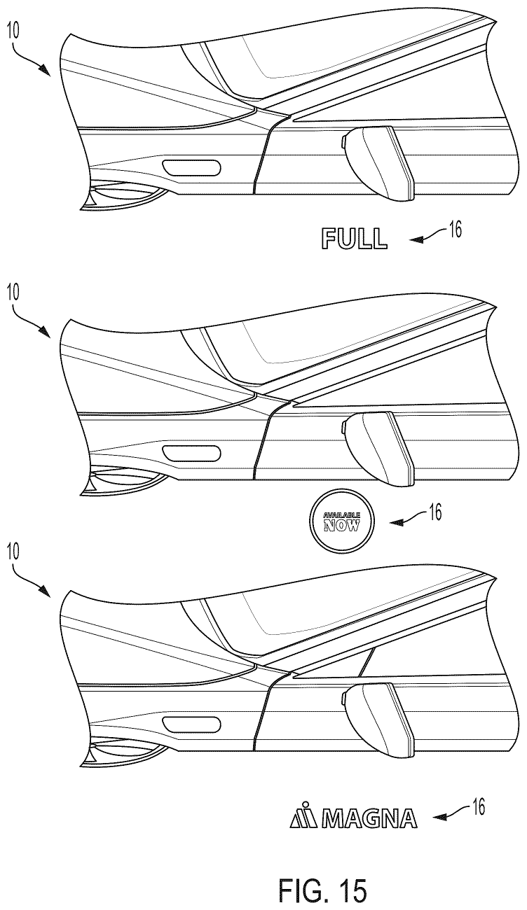

The vehicle 10 may be a service vehicle or a fleet vehicle (e.g., a taxi or delivery vehicle or vehicle used for a rideshare service) and the illumination module 14 may be operated to display an image 16 related to a status or condition of the vehicle or related service (FIG. 15). For example, when equipped at a taxi or rideshare vehicle, the illumination module 14 may be operated to display an occupancy status (e.g., available or not available) or a logo associated with the rideshare service. For a delivery vehicle, the illumination module 14 may be operated to display a status or condition related to the delivery, such as a logo associated with the delivery service.

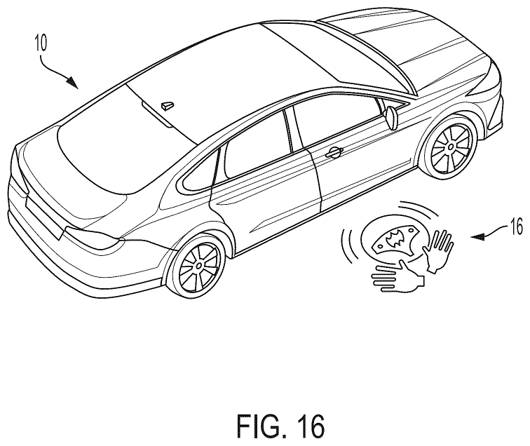

As shown in FIG. 16, the illumination module 14 may be operated to display images 16 related to operation of the vehicle 10, such as based on signals from one or more systems of the vehicle. In the illustrated example, the illumination module 14 is operated to display an image 16 indicating that the vehicle is being operated in a hands-free or at least partially autonomous driving mode. Optionally, the illumination module 14 may be operated to display images 16 related to a driver monitoring system (DMS) or occupant monitoring system (OMS), such as to display images 16 corresponding to a determined level of attentiveness or distraction of the driver. Further, the illumination module 14 may be operated to display a lock status of one or more of the vehicle doors (e.g., a respective image indicating the lock status of each door may be illuminated at the ground surface near each respective door). Similarly, the illumination module 14 may be operated to display an occupancy status of a vehicle seat near one or more of the doors. Thus, a potential passenger exterior the vehicle may know whether a specific seat of the vehicle is occupied before approaching the corresponding door of the vehicle 10. Occupancy may be determined based on a cabin monitoring system or occupant monitoring system of the vehicle, based on seat belt sensors of the vehicle, based on sensors in the seat of the vehicle, and the like.

As shown in FIG. 4, the substrate of the mask 22 may include patterns at respective portions or regions corresponding to each image 16 that the illumination module 14 is configured to project. To project one of the plurality of images, the illumination module 14 energizes the LED corresponding to the desired image 16. Although shown as including three patterns at the mask 22, it should be understood that the illumination module 14 may be configured to project any suitable number of different images 16, such as 10 or more images, 15 or more images, and the like.

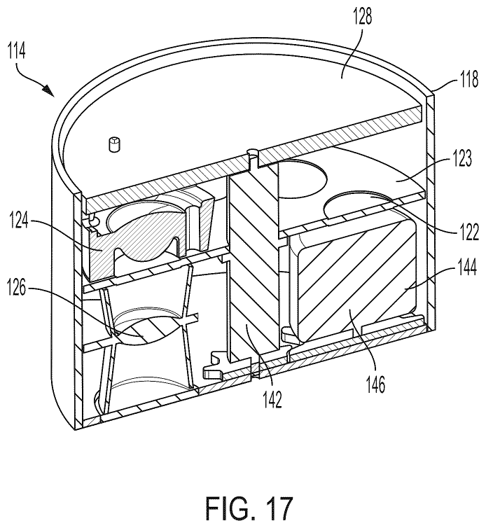

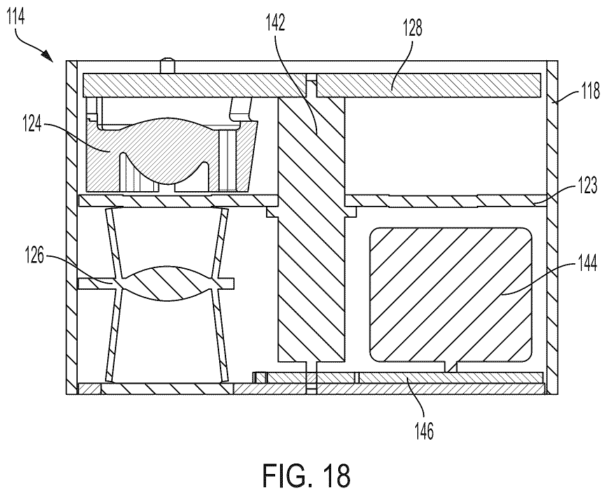

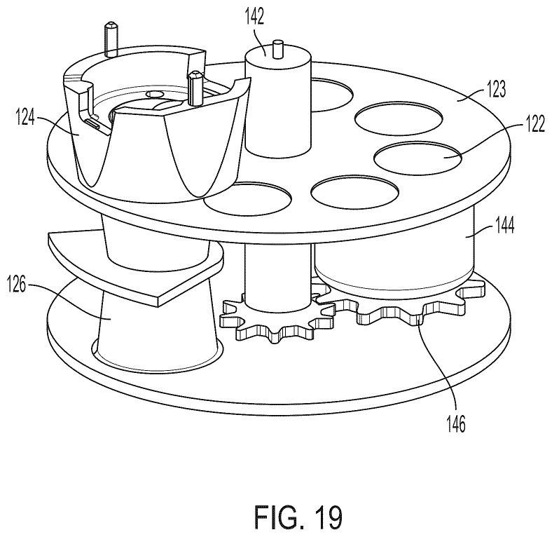

Optionally, the illumination module may include one or more light sources that are operated to emit light when the illumination module is electrically operated, and the mask or mask layer or masking element may move or adjust relative to the light source to change or alter the image projected by the illumination module. For example, and referring to FIGS. 17-21, a projection module 114 includes a housing 118 configured for attachment at an exterior component of the vehicle, such as the exterior rearview mirror head or the door handle module. The housing 118 accommodates a PCB 128 that includes one or more light sources, such as one or more LEDs or microLEDs that are electrically operable to emit light through one or more masks or glass layers 122 within the module 114. For example, the LEDs may be configured to emit light of different wavelengths (e.g., visible white light, visible colored light, near infrared light having wavelengths between about 700 nm and about 940 nm, infrared light having wavelengths greater than about 940 nm, ultraviolet light having wavelengths less than about 380 nm, and the like).

The illumination module 114 includes a plurality of masks 122 (e.g., a plurality of respective substrates having respective patterns formed thereat) disposed at a rotating disk or plate 123 that rotates relative to the light sources at the PCB 128 to position different ones of the masks 122 in the illumination path of the light sources. The illumination module 114 further includes a condensing optic or collimator 124 and or more projection lenses 126 that focus and magnify light as it passes from the light source, through one of the plurality of mask substrates and out of the illumination module 114. As shown in FIGS. 17-19, the plate 123 is disposed between the collimator 124 and the projection lens 126 so that, with a respective mask 122 aligned with the collimator 124, light emitted by the light sources passes through the collimator 124, through the individual mask 122 and through the projection lens 126 to project the image associated with the mask 122 at the ground near the vehicle. To change the image being projected, the plate 123 is rotated to position a different mask 122 between the collimator 124 and the projection lens 126.

The plate 123 may be mounted to and rotatable with a drive shaft 142 disposed within the housing 118 of the illumination module 114 and the illumination module 114 includes an electrically operable motor 144 that is operable to rotate the drive shaft 142 and the plate 123. For example, a gear train 146 may operably couple the motor 144 and the drive shaft 142. Thus, when the motor 144 is operated, the plate 123 rotates within the housing 118 and the image projected by the illumination module 114 is adjusted based on the changing of the mask 122 in front of the light sources.

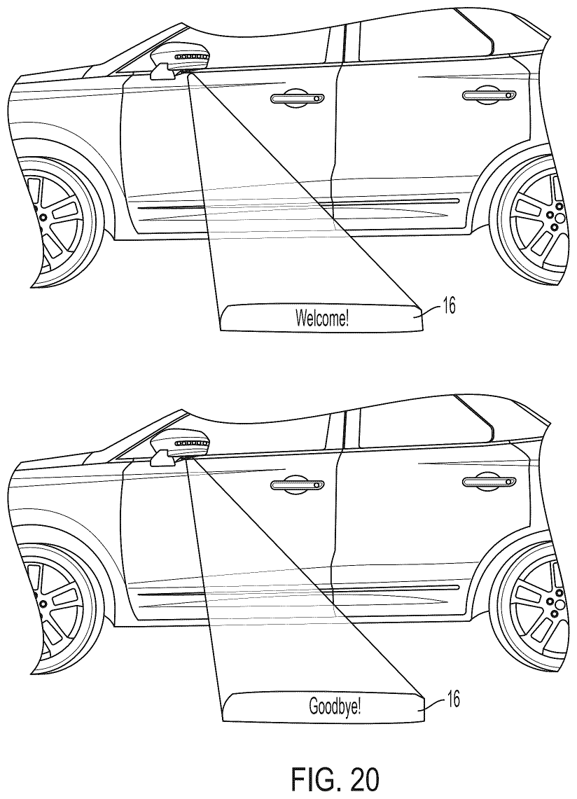

As shown in FIG. 20, the illumination module 114 may be operated to project static images 16, as described above, where the plate 123 is rotated and the images 16 are adjusted based on the desired image to be projected. That is, the plate 123 is rotated to change the mask 122 that is positioned within the illumination path of the illumination module 114 based on the image 16 to be projected. The illumination module 114 may not emit light as the plate 123 is rotated and begin emitting light when the desired mask 122 is positioned within the illumination path, which may be determined based on tracking rotation of the motor or via sensing one or more markers at the plate 123. The illumination module 114 having the rotating plate 123 may allow the illumination module 114 to display a larger number of different images 16, such as four or more, eight or more, ten or more, and the like, and thus display images 16 corresponding to a wider variety of vehicle systems.

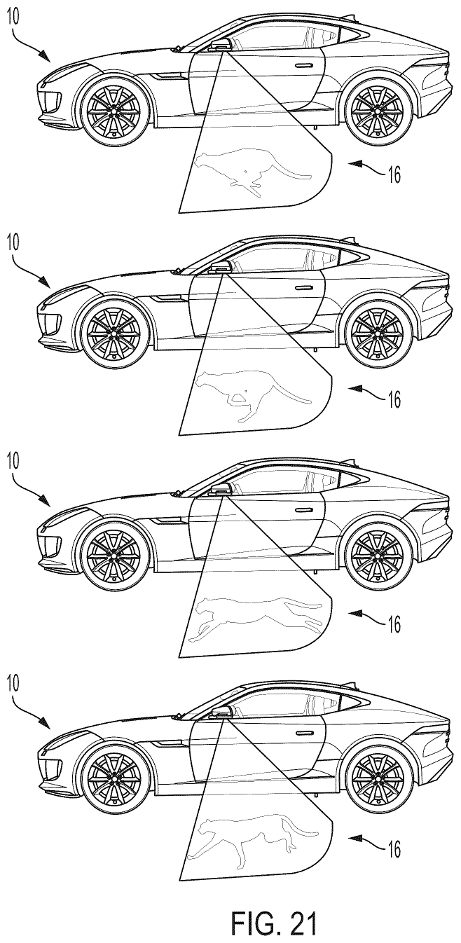

Optionally, the illumination module 114 may be operated to continuously or rapidly change the mask 122 providing the image 16, such that the projected images 16 may appear as an animation (FIG. 21). In other words, the illumination module 114 may rapidly change the mask 122 providing the image 16 so that the series of projected images 16 appear as an animation or moving or evolving image. The illumination module 114 may rotate the plate 123 at a constant speed while continuously emitting light so that the images 16 appear animated. For example, the illumination module 114 may project a series of images 16 that appear as a moving arrow, responsive to a turn signal indicator of the vehicle being activated, to signal a turning direction of the vehicle 10. Optionally, the animation may display a welcome message, a goodbye message, and the like.

Thus, the illumination module provides greater functionality beyond a single, static logo light with dynamic adjustment based on change in vehicle status and/or a user input. The rotatable logo light may be driven by an electric motor with the possibility of displaying a different number of images or logos (e.g., four to eight or more), with the higher number of logos requiring a larger packaging size of the illumination module. Different operating modes may be manually controlled by the user, such as via an input within the interior cabin of the vehicle. For example, the operating modes may display a logo, a word mark or text message, a welcome message responsive to unlocking the vehicle, a goodbye message responsive to locking the vehicle, and/or an animation. The illumination module illuminates a portion of the ground surface with a minimum lux value in the defined area. The logo, which may be colored or tinted, may be produced by a light source emitting only white light. The illumination module has a small enough packaging size to fit into the vehicle exterior component, like the exterior rearview mirror assembly or the door handle module. Further, the illumination module may provide precise control over the motor to stop the plate in the right position for each mask and rotate at a right speed to produce an animation effect.

The mirror assembly may utilize aspects of the mirror assemblies described in U.S. Publication Nos. US-2021-0331625; US-2021-0316664; US-2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

The illumination source may comprise any suitable illumination source, such as one or more light emitting diodes (LEDs), such as white light-emitting LEDs or high intensity power LEDs (such as the types described in U.S. Pat. No. 7,195,381 and/or 6,690,268, which are hereby incorporated herein by reference in their entireties) or organic light emitting diodes (OLEDs) or electroluminescent light sources or the like. The illumination source may comprise a substantially white light-emitting illumination source, or may comprise a colored light-emitting illumination source (or a white light-emitting illumination source may emit light that passes through a color filter or the like) to provide color illumination (such as blue or other color as desired) at the vehicle side area depending on the particular application of the illumination module. For example, the illumination module may emit colored light that may match or correspond to the interior and/or exterior lighting of the particular vehicle to which the illumination module is mounted.

The icon or indicia or logo or emblem may comprise the vehicle manufacturer logo or the like, or may comprise a selected icon or indicia or logo, such as may be selected by the owner of the vehicle. For example, the owner of the vehicle may select a module having a desired icon or indicia or logo element or optical properties and the selected illumination module may be installed in the vehicle door handle and/or mirror assembly (or elsewhere on the vehicle, such as at or on or in the vehicle door or at or on or in a side panel of the vehicle or the like) to provide the customized or personalized ground illumination function. Such a selection and installation of the illumination module may be performed during manufacturing of the vehicle or as an aftermarket change to the vehicle. The icon illumination module thus may provide a personalized or customized illumination at the side of the vehicle, such as by utilizing aspects of the systems and assemblies described in U.S. Pat. Nos. 7,626,749; 7,255,451 and/or 7,289,037, which are hereby incorporated herein by reference in their entireties. Optionally, the illumination module may be disposed at an exterior rearview mirror assembly of the vehicle (such as at the housing of the mirror assembly or in the housing and behind the reflective element so as to be viewable through the reflective element) or the like, or may be disposed elsewhere at the exterior of the vehicle, such as at a door handle of the vehicle or the like. Optionally, the illumination module may be disposed at a lower region of the vehicle, such as at a lower region of a vehicle door, whereby the illumination module is activated to project the icon onto a ground region when the door is opened. Optionally, an illumination module with a backlit icon of the types described above may be disposed at an interior portion of a vehicle, such as at an interior rearview mirror assembly (such as at a mirror casing or behind a reflective element and viewable through the reflective element or the like) of the vehicle or such as at or proximate to the interior door lock button or switch or the like. For example, the illumination module may be mounted at the interior rearview mirror assembly, an overhead console module or at the headliner of the vehicle and operate to project the icon onto an interior region or surface of the vehicle (such as the dashboard, center console, floor, and the like). The illumination module thus may provide a security indicator function at the interior rearview mirror assembly or elsewhere in the interior cabin of the vehicle.

Optionally, the cover and/or housing may be overmolded over the illumination source or sources and circuitry to provide a substantially sealed and substantially water impervious illumination module. For example, the housing may be overmolded over and around a metal stamping or stamped circuit element or plate with the illumination source or sources (such as LEDs or the like) fastened thereto or otherwise established thereon, or the housing may be overmolded over and around a printed circuit board or element with the illumination sources established thereon.

Thus, the present invention provides an illumination module at an exterior portion of the vehicle. Optionally, the illumination device or module of the present invention may be operable as an indicator to provide the driver with feedback as the driver or user or operator uses his or her keyfob or as the passive or keyless entry system (PKE system) of the vehicle operates. Optionally, the illumination device or module may display vehicle logos or the like, and may use variable color LEDs that could be linked to an interior lighting system of the vehicle, such as to a MYCOLOR™ interior lighting system of the vehicle or the like.

Although shown and described as being disposed at an exterior rearview mirror assembly and/or door handle and/or exterior portion of a vehicle for providing illumination at a side of a vehicle, it is envisioned that the light module of the present invention is suitable for other applications. For example, a light module of the present invention may be disposed at an interior portion of a vehicle, such as at an interior rearview mirror assembly (such as at a mirror casing or behind a reflective element and viewable through the reflective element or the like) of the vehicle or the like, whereby actuation of the light module may provide broad illumination of the dashboard and/or instrument panel of the vehicle (generally beneath the mirror assembly), and may project a beam of light to illuminate (such as at a greater intensity of light as compared to the broad illumination) a targeted portion of the interior of the vehicle (such as for map reading or the like). Also, for example, a light module of the present invention may be suitable for use in non-automotive lighting applications, such as residential lighting or commercial lighting or the like. For example, a light module of the present invention may be converted to replace a household or residential or commercial business or office building light bulb, whereby the light module may provide normal lighting (that broadly illuminates the area surrounding the light module) in addition to projection lighting, such as in a similar manner as described above.

Changes and modifications in the specifically described embodiments may be carried out without departing from the principles of the present invention, which is intended to be limited only by the scope of the appended claims as interpreted according to the principles of patent law.

1. A vehicular illumination module, the vehicular illumination module comprising:
a housing configured to be disposed at an exterior portion of a vehicle equipped with the vehicular illumination module;
a printed circuit board (PCB) accommodated by the housing;
an illumination source disposed at the PCB;
a masking element accommodated by the housing, wherein the masking element comprises a plurality of patterns, and wherein each pattern of the plurality of patterns is disposed at a respective portion of the masking element;
wherein, with the housing disposed at the exterior portion of the vehicle, and when the illumination source is electrically operated to emit light, and in response to a first input, light emitted by the illumination source passes through a first portion of the masking element corresponding to a first pattern of the plurality of patterns and forms a first icon projected by the vehicular illumination module onto a surface on or proximate the vehicle; and
wherein, with the housing disposed at the exterior portion of the vehicle, and when the illumination source is electrically operated to emit light, and in response to a second input, light emitted by the illumination source passes through a second portion of the masking element corresponding to a second pattern of the plurality of patterns and forms a second icon projected by the vehicular illumination module onto the surface on or proximate the vehicle.

2. The vehicular illumination module of claim 1, wherein the illumination source comprises a single light emitting diode.

3. The vehicular illumination module of claim 1, wherein, when the illumination source is electrically operated to emit light and the vehicular illumination module projects the first icon onto the surface on or proximate the vehicle, light emitted by the illumination source does not pass through the second portion of the masking element, and wherein, when the illumination source is electrically operated to emit light and the vehicular illumination module projects the second icon onto the surface on or proximate the vehicle, light emitted by the illumination source does not pass through the first portion of the masking element.

4. The vehicular illumination module of claim 1, wherein the masking element comprises a substrate, and wherein the plurality of patterns are formed at respective portions of the substrate.

5. The vehicular illumination module of claim 1, wherein the masking element comprises a plurality of substrates, and wherein each pattern of the plurality of patterns is formed at one respective substrate of the plurality of substrates, and wherein the plurality of substrates are movable relative to the illumination source to align a first substrate of the plurality of substrates with the illumination source for projecting the first icon and to align a second substrate of the plurality of substrates with the illumination source for projecting the second icon.

6. The vehicular illumination module of claim 1, wherein at least one selected from the group consisting of (i) the first input comprises a user input and (ii) the second input comprises a user input.

7. The vehicular illumination module of claim 6, wherein the user input is at a keyfob associated with the vehicle.

8. The vehicular illumination module of claim 1, wherein at least one selected from the group consisting of (i) the first input comprises a signal from a system of the vehicle and (ii) the second input comprises a signal from a system of the vehicle.

9. The vehicular illumination module of claim 1, wherein the exterior portion comprises an exterior rearview mirror assembly of the vehicle.

10. The vehicular illumination module of claim 1, wherein the exterior portion comprises a door handle module of the vehicle.

11. The vehicular illumination module of claim 1, wherein the surface comprises a ground surface at a side of the vehicle.

12. The vehicular illumination module of claim 1, wherein the masking element is movable relative to the illumination source in response to at least one selected from the group consisting of (i) the first input and (ii) the second input.

13. A vehicular illumination module, the vehicular illumination module comprising:
a housing configured to be disposed at an exterior portion of a vehicle equipped with the vehicular illumination module;
a printed circuit board (PCB) accommodated by the housing;
a single light emitting diode (LED) disposed at the PCB;
a masking element accommodated by the housing, wherein the masking element comprises a plurality of patterns formed at the masking element, and wherein each pattern of the plurality of patterns is disposed at a respective portion of the masking element;
wherein, with the housing disposed at the exterior portion of the vehicle, and when the single LED is electrically operated to emit light, light emitted by the single LED passes through a first portion of the masking element corresponding to a first pattern of the plurality of patterns and forms a first icon projected by the vehicular illumination module onto a surface on or proximate the vehicle; and
wherein, with the housing disposed at the exterior portion of the vehicle, and when the single LED is electrically operated to emit light, light emitted by the single LED passes through a second portion of the masking element corresponding to a second pattern of the plurality of patterns and forms a second icon projected by the vehicular illumination module onto the surface on or proximate the vehicle.

14. The vehicular illumination module of claim 13, wherein, when the single LED is electrically operated to emit light and the vehicular illumination module projects the first icon onto the surface on or proximate the vehicle, light emitted by the single LED does not pass through the second portion of the masking element, and wherein, when the single LED is electrically operated to emit light and the vehicular illumination module projects the second icon onto the surface on or proximate the vehicle, light emitted by the single LED does not pass through the first portion of the masking element.

15. The vehicular illumination module of claim 13, wherein the masking element comprises a substrate, and wherein the plurality of patterns is formed at respective portions of the substrate.

16. The vehicular illumination module of claim 13, wherein the masking element comprises a plurality of substrates, and wherein each pattern of the plurality of patterns is formed at one respective substrate of the plurality of substrates, and wherein the plurality of substrates is movable relative to the single LED to align a first substrate of the plurality of substrates with the single LED for projecting the first icon and to align a second substrate of the plurality of substrates with the single LED for projecting the second icon.

17. A vehicular illumination module, the vehicular illumination module comprising:
a housing configured to be disposed at an exterior portion of a vehicle equipped with the vehicular illumination module;
a printed circuit board (PCB) accommodated by the housing;
an illumination source disposed at the PCB;
a masking element accommodated by the housing, wherein the masking element comprises a plurality of patterns formed at the masking element, and wherein each pattern of the plurality of patterns is disposed at a respective portion of the masking element;
wherein the masking element is movable relative to the illumination source;
wherein, with the housing disposed at the exterior portion of the vehicle, and when the illumination source is electrically operated to emit light, and in response to a first input, (i) the masking element moves relative to the illumination source to align the illumination source with a first portion of the masking element corresponding to a first pattern of the plurality of patterns and (ii) light emitted by the illumination source passes through the first portion of the masking element and forms a first icon projected by the vehicular illumination module onto a surface on or proximate the vehicle; and
wherein, with the housing disposed at the exterior portion of the vehicle, and when the illumination source is electrically operated to emit light, and in response to a second input, (i) the masking element moves relative to the illumination source to align the illumination source with a second portion of the masking element corresponding to a second pattern of the plurality of patterns and (ii) light emitted by the illumination source passes through the second portion of the masking element and forms a second icon projected by the vehicular illumination module onto the surface on or proximate the vehicle.

18. The vehicular illumination module of claim 17, wherein the illumination source comprises a single light emitting diode.

19. The vehicular illumination module of claim 17, wherein, when the illumination source is electrically operated to emit light and the vehicular illumination module projects the first icon onto the surface on or proximate the vehicle, light emitted by the illumination source does not pass through the second portion of the masking element, and wherein, when the illumination source is electrically operated to emit light and the vehicular illumination module projects the second icon onto the surface on or proximate the vehicle, light emitted by the illumination source does not pass through the first portion of the masking element.

20. The vehicular illumination module of claim 17, wherein at least one selected from the group consisting of (i) the first input comprises a user input at a keyfob associated with the vehicle and (ii) the second input comprises a user input at a keyfob associated with the vehicle.
